(19) United States
(12) Patent Application Publication
(10) Pub. No.: US 2024/0079888 A1
(43) Pub. Date: Mar. 7, 2024

(54) SECONDARY BATTERY PROTECTION INTEGRATED CIRCUIT, POWER SUPPLY SYSTEM, AND BATTERY DEVICE

(71) Applicants: Takeshi YAMAGUCHI, Tokyo (JP); Junji TAKESHITA, Tokyo (JP)

(72) Inventors: Takeshi YAMAGUCHI, Tokyo (JP); Junji TAKESHITA, Tokyo (JP)

(73) Assignee: MITSUMI ELECTRIC CO., LTD., Tokyo (JP)

(21) Appl. No.: 18/366,265

(22) Filed: Aug. 7, 2023

(30) Foreign Application Priority Data
Sep. 2, 2022 (JP) 2022-139926

(51) Int. Cl. H02J 7/00

(52) U.S. Cl. CPC H02J 7/0034; H02J 7/00302; H02J 7/00306

(57) ABSTRACT

A secondary battery protection integrated circuit includes a first power supply terminal, a second power supply terminal, an input terminal, an output terminal, and a control circuit. The control circuit turns a discharge control transistor off to change to a discharge-blocked state in which the output terminal and the first power supply terminal are coupled to each other, upon occurrence in a condition in which a potential level of the input terminal changes from a first level. The control circuit turns the discharge control transistor on in the discharge blocked state, upon occurrence of a condition in which the input terminal changes from a second level that is different from the first level.

### CROSS-REFERENCE TO RELATED APPLICATION

This application claims priority under 35 U.S.C. § 119 to Japanese Patent Application No. 2022-139926, filed Sep. 2, 2022, the contents of which are incorporated herein by reference in their entirety.

### BACKGROUND

### 1. Technical Field

The present disclosure relates to a secondary battery protection integrated circuit, a power supply system, and a battery device.

### 2. Description of the Related Art

A conventional circuit is known to protect a secondary battery by turning a discharge field effect transistor (FET) off. The discharge FET is inserted in a charge-and-discharge current path between a negative electrode of the secondary battery and a negative terminal that is to be connected to a ground of a load (see, for example, Patent Document 1). This circuit includes a terminal to which a control signal is applied, and when the control signal is applied to the terminal, the circuit turns itself into a powered-down state and turns the discharge FET off, thereby suppressing the power consumption of the secondary battery.

### RELATED-ART DOCUMENT

### Patent Document

Patent Document 1: Japanese Unexamined Patent Application Publication No. 2012-257407

In the related art, a charger is required to be connected to release the powered-down state of the circuit. For this reason, the powered-down state cannot be released without a charger, which may result in poor usability.

The present disclosure provides a technique for improving convenience in releasing a powered-down state.

### SUMMARY

In one aspect of the present disclosure, a secondary battery protection integrated circuit is provided. The secondary battery protection integrated circuit protects a secondary battery by inserting a discharge control transistor in a discharge path that is coupled to a first electrode and blocking the discharge path, in a case where a first power supply terminal is coupled to a first electrode of the secondary battery and a second power supply terminal is coupled to a second electrode of the secondary battery. The secondary battery protection integrated circuit includes:
the first power supply terminal;
the second power supply terminal;
an input terminal;
an output terminal; and
a control circuit configured to:
   turn the discharge control transistor off to change to a discharge-blocked state in which the output terminal and the first power supply terminal are coupled to each other, upon occurrence in a condition in which a potential level of the input terminal changes from a first level, and
   turn the discharge control transistor on in the discharge blocked state, upon occurrence of a condition in which the input terminal changes from a second level that is different from the first level.

In a second aspect of the present disclosure, a secondary battery protection integrated circuit is provided. The secondary battery protection integrated circuit protects a secondary battery by inserting a discharge control transistor in a discharge path that is coupled to a first electrode and blocking the discharge path, in a case where a first power supply terminal is coupled to a first electrode of the secondary battery and a second power supply terminal is coupled to a second electrode of the secondary battery. The secondary battery protection integrated circuit includes:
the first power supply terminal;
the second power supply terminal;
an input-and-output terminal; and
a control circuit configured to:
   turn the discharge control transistor off to change to a discharge-blocked state in which the input-and-output terminal and the first power supply terminal are coupled to each other, upon occurrence in a condition in which a potential level of the input terminal changes from a first level, and
   turn the discharge control transistor on in the discharge blocked state, upon occurrence of a condition in which the input terminal changes from a second level that is different from the first level.

### BRIEF DESCRIPTION OF THE DRAWINGS

FIG. 1 is a diagram illustrating an example of the configuration of a power supply system according to a first embodiment;

FIG. 2 is a timing chart illustrating an operation example of the power supply system according to the first embodiment;

FIG. 3 is a diagram illustrating an example of the configuration of a power supply system according to a second embodiment;

FIG. 4 is a timing chart illustrating an operation example of the power supply system according to the second embodiment;

FIG. 5 is a diagram illustrating an example of the configuration of a control circuit in a secondary battery protection integrated circuit according to the second embodiment;

FIG. 6 is a diagram illustrating an example of the configuration of a power supply system according to a third embodiment;

FIG. 7 is a timing chart illustrating an operation example of the power supply system according to the third embodiment;

FIG. 8 is a diagram illustrating an example of the configuration of a control circuit in a secondary battery protection integrated circuit according to the third embodiment;

FIG. 9 is a diagram illustrating an example of the configuration of a power supply system according to a fourth embodiment;

FIG. 10 is a timing chart illustrating an operation example of the power supply system according to the fourth embodiment;

FIG. 11 is a diagram illustrating an example of the configuration of a power supply system according to a fifth embodiment; and

FIG. 12 is a timing chart illustrating an operation example of the power supply system according to the fifth embodiment.

### DETAILED DESCRIPTION

Embodiments of the present disclosure will be described below with reference to the drawings.

### First Embodiment

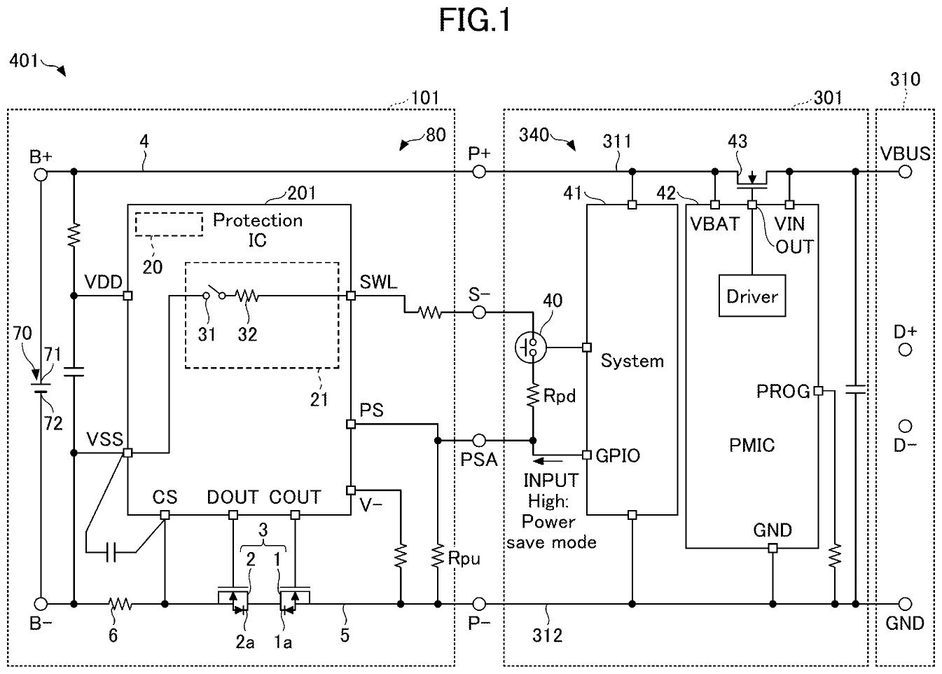

FIG. 1 is a diagram illustrating an example of the configuration of a power supply system according to a first embodiment. A power supply system 401 illustrated in FIG. 1 is a system using a secondary battery 70 as a power supply. The power supply system 401 includes a battery device 101, an external circuit 340, and a USB port 310. The external circuit 340 and the USB port 310 are included in an electronic device 301.

The battery device 101 includes the secondary battery 70 and a battery protection circuit 80. The secondary battery 70 and the battery protection circuit 80 are incorporated in the battery device 101. The battery device 101 may be embedded in the electronic device 301, or may be coupled to an external battery device. The battery device 101 is, for example, a battery pack.

The secondary battery 70 is an example of a rechargeable battery. The secondary battery 70 supplies power to the electronic device 301 that is connected between a terminal P+ and a terminal P− (or a load (not illustrated) connected between a terminal VBUS and a terminal GND of the USB port 310). The secondary battery 70 can be charged by a charger that is coupled between the terminal P+ and the terminal P− (or a charger that is coupled between the terminal VBUS and the terminal GND of the USB port 310). A specific example of the secondary battery 70 includes a lithium ion battery, a lithium polymer battery, or the like. The secondary battery 70 includes a positive electrode 71 and a negative electrode 72.

The electronic device 301 is an example of a load that is powered by the secondary battery 70 in the battery device 101. A specific example of the electronic device 301 includes a portable device such as a cellular phone, a smartphone, a tablet, or an earphone. The electronic device 301 is not limited to the above devices.

The battery protection circuit 80 is an example of a secondary battery protection integrated circuit that operates with power that is supplied from the secondary battery 70 as a power source. By controlling the charge or discharge of the secondary battery 70, the battery protection circuit 80 protects the secondary battery 70 from overcharge, overdischarge, or the like. The battery protection circuit 80 includes the terminal P+, the terminal P−, a terminal B+, a terminal B−, a terminal S−, a terminal PSA, a resistance element Rpu, a switching circuit 3, and a protection integrated circuit (IC) 201.

The terminal P+ is an example of a positive-side load terminal, and a power line 311 of the electronic device 301 is connected to the terminal P+. The terminal P− is an example of a negative-side load terminal, and a ground line 312 of the electronic device 301 is connected to the terminal P−. The terminal B+ is an example of a positive-side battery electrode terminal and a positive electrode 71 of the secondary battery 70 is connected to the terminal B+. The terminal B− is an example of a negative-side battery electrode terminal and a negative electrode 72 of the secondary battery 70 is connected to the terminal B−.

The terminal B+ and the terminal P+ are connected to each other via a positive-side current path 4. The positive-side current path 4 is a power supply path between the terminal B+ and the terminal P+. The positive-side current path 4 is a charging path through which a charge current flows into the secondary battery 70 or a discharging path through which a discharge current flows out of the secondary battery 70. The positive-side current path 4 is an example of a charge-and-discharge current path between the positive electrode 71 of the secondary battery 70 and the terminal P+.

The terminal B− and the terminal P− are connected to each other by a negative-side current path 5. The negative-side current path 5 is a current path between the terminal B− and the terminal P−. The negative-side current path 5 is a charging path through which a charge current flows into the secondary battery 70 or a discharging path through which a discharge current flows out of the secondary battery 70. The negative-side current path 5 is an example of a charge-and-discharge current path between the negative electrode 72 of the secondary battery 70 and the terminal P−.

The switching circuit 3 is inserted in series into the negative-side current path 5 between the terminal B− and the terminal P−. The switching circuit 3 includes, for example, a charge control transistor 1 and a discharge control transistor 2. The switching circuit 3 is a series circuit in which the charge control transistor 1 and the discharge control transistor 2 are connected in series. The charge control transistor 1 is an example of a charge-path block circuit that blocks a charge path used for the secondary battery 70. The discharge control transistor 2 is an example of a discharge-path block circuit that blocks a discharge path used for the secondary battery 70.

In the illustrated case, the charge control transistor 1 blocks the negative-side current path 5 through which the charge current flows into the secondary battery 70, and the discharge control transistor 2 blocks the negative-side current path 5 through which the discharge current flows out of the secondary battery 70. The charge control transistor 1 and the discharge control transistor 2 are switching elements each of which switches between conduction and interruption of the negative-side current path 5, and are inserted in series into the negative-side current path 5. Each of the charge control transistor 1 and the discharge control transistor 2 is, for example, an N-channel metal oxide semiconductor field effect transistor (MOSFET).

The charge control transistor 1 includes a parasitic diode 1a between a drain and a source, and the parasitic diode 1a causes the current to flow in a forward direction opposite to a direction in which the charge current flows into the secondary battery 70. The charge control transistor 1 is a switching element that is inserted in the negative-side current path 5, such that the forward direction of the parasitic diode 1a in the charge control transistor 1 coincides with the direction in which the discharge current flows out of the secondary battery 70.

The discharge control transistor 2 includes a parasitic diode 2a between a drain and a source, and the parasitic diode 2a causes the current to flow in a forward direction opposite to a direction in which the discharge current flows out of the secondary battery 70. The discharge control transistor 2 is a switching element that is inserted in the negative-side current path 5, such that the forward direction of the parasitic diode 2a in the discharge control transistor 2 coincides with the direction in which the charge current flows into the secondary battery 70.

The protection IC 201 is an example of a secondary battery protection integrated circuit. The protection IC 201 operates with power that is supplied from the secondary battery 70 as a power source. The protection IC 201 is, for example, an integrated circuit (IC) that operates with a battery voltage (hereinafter also referred to as a “cell voltage”) between the positive electrode 71 and the negative electrode 72 of the secondary battery 70.

The protection IC 201 protects the secondary battery 70 from overdischarge or the like, by controlling the switching circuit 3. For example, the protection IC 201 protects the secondary battery 70 from a charging abnormality (for example, overcharge, overcurrent (charge overcurrent) flowing in the charging direction, or the like) by turning the charge control transistor 1 off. The protection IC 201 also protects the secondary battery 70 from a discharge abnormality (for example, overdischarge, overcurrent (discharge overcurrent) flowing in the discharge direction, or the like) by turning the discharge control transistor 2 off.

The protection IC 201 includes, for example, a charging control terminal (terminal COUT), a discharging control terminal (terminal DOUT), a monitoring terminal (terminal V−), a power supply terminal (terminal VDD), a ground terminal (terminal VSS), a current detection terminal (terminal CS), an input terminal (terminal PS), and an output terminal (terminal SWL). These terminals are external connection terminals that are used to connect an internal circuit of the protection IC 201 to the outside of the protection IC 201.

The terminal COUT is connected to a gate (control terminal) of the charge control transistor 1, and a signal to turn on or off the charge control transistor 1 is output via the terminal COUT. The terminal DOUT is connected to a gate (control terminal) of the discharge control transistor 2, and a signal to turn on or off the discharge control transistor 2 is output via the terminal DOUT.

The terminal V− is connected to the terminal P− to monitor the potential at the terminal P−. The terminal V− is used by a detection circuit within the protection IC 201 to, for example, monitor the presence or absence of a connection with the electronic device 301 or the charger. The terminal V− is connected to a node in the negative-side current path 5 between the switching circuit 3 and the terminal P−.

The terminal VDD is a power supply terminal of the protection IC 201 and is connected to the positive electrode 71 of the secondary battery 70, via the positive-side current path 4. The terminal VSS is a ground node of the protection IC 201 and is connected to the negative electrode 72 of the secondary battery 70, via the negative-side current path 5. The terminal VSS is connected to a node in the negative-side current path 5 between the switching circuit 3 and the terminal B−. In other words, the terminal VSS is connected to a node in the negative-side current path 5 between the discharge control transistor 2 and the negative electrode 72. In this example, the terminal VSS is connected to a node in the negative-side current path 5 between a sense resistor 6 and the negative electrode 72.

The terminal CS is connected to a node in the negative-side current path 5 between the discharge control transistor 2 of the switching circuit 3 and the sense resistor 6. The sense resistor 6 is a current detection resistor inserted in series into the negative-side current path 5 between the switching circuit 3 and the terminal B−. The sense resistor 6 is inserted in series into the negative-side current path 5 between the discharge control transistor 2 and the negative electrode 72.

The terminal PS is connected to the terminal PSA and the resistance element Rpu. The terminal PS is connected to a node in the negative-side current path 5 between the switching circuit 3 and the terminal P− via the resistance element Rpu. A command signal (forced shut-down signal) that reduces the power consumption of the protection IC 201 is input to the terminal PS from the terminal PSA.

The terminal SWL is connected to the terminal S−. The terminal SWL and the terminal VSS are connected to each other via an internal switch 31 and an internal resistor 32 in the protection IC 201. The internal switch 31 and the internal resistor 32 are incorporated in the protection IC 201.

The protection IC 201 performs a protection operation of the secondary battery 70. The protection IC 201 includes an abnormality detection circuit 20 and a control circuit 21. The abnormality detection circuit 20 is an example of a unit to detect an abnormality in the current or voltage of the secondary battery 70. The control circuit 21 includes a switch control circuit that turns the charge control transistor 1 or the discharge control transistor 2 of the switching circuit 3 on or off based on the abnormality detection result detected by the abnormality detection circuit 20. The control circuit 21 and the switch control circuit are configured by, for example, a logic circuit.

The abnormality detection circuit 20 monitors a power supply voltage Vd between the terminal VDD and the terminal VSS. The control circuit 21 turns the charge control transistor 1 off when the power supply voltage Vd higher than a predetermined overcharge detection voltage VDET1 is detected by the abnormality detection circuit 20. The control circuit 21 turns the charge control transistor 1 on when the power supply voltage Vd lower than a predetermined overcharge recovery voltage VRET1 is detected by the abnormality detection circuit 20. The control circuit 21 turns the discharge control transistor 2 off when the power supply voltage Vd lower than a predetermined overdischarge detection voltage VDET2 is detected by the abnormality detection circuit 20. The control circuit 21 turns the discharge control transistor 2 on when the power supply voltage Vd higher than a predetermined overdischarge recovery voltage VRET2 is detected by the abnormality detection circuit 20.

The external circuit 340 includes a resistance element Rpd, a switch 40, a system circuit 41, a PMIC 42, and a voltage control switch 43. The external circuit 340 is, for example, a power supply circuit for the electronic device 301.

The switch 40 is provided outside the protection IC 201 and switches between connection and disconnection between the terminal PS and the terminal SWL. In this example, the switch 40 is provided outside the battery device 101. A series circuit in which the switch 40 and the resistance element Rpd are connected in series is inserted between the terminal S− and the terminal PSA. The switch 40 is, for example, an element that is turned on or off by a user's operation. The switch 40 is, for example, a power switch of the electronic device 301, but may be a switch other than the power switch.

The system circuit 41 outputs a forced shut-down signal from a terminal GPIO when a predetermined condition is satisfied. The system circuit 41 operates with an internal power supply voltage between the power line 311 and the ground line 312. The terminal GPIO is a general-purpose input-and-output terminal.

The PMIC 42 is a power management integrated circuit to control the internal power supply voltage between the power line 311 and the ground line 312 to a predetermined target voltage value using the voltage control switch 43. The PMIC 42 steps an external voltage between the terminal VBUS and the terminal GND down or up to generate the internal power supply voltage between the power line 311 and the ground line 312. Alternatively, the PMIC 42 steps the internal power supply voltage between the power line 311 and the ground line 312 down or up to generate the external voltage between the terminal VBUS and the terminal GND.

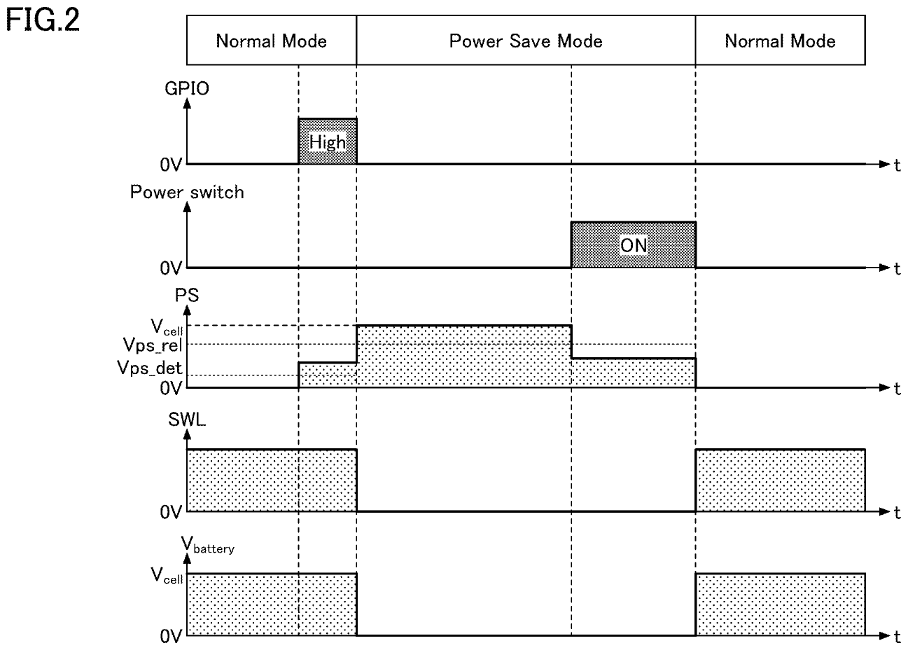

FIG. 2 is a timing chart illustrating an operation example of the power supply system according to the first embodiment. FIG. 2 illustrates operation mode transition of the protection IC 201. FIG. 2 will now be described with reference to FIG. 1.

In FIG. 2, “GPIO” represents a voltage level at the terminal GPIO. “Power switch” represents an on-state or off-state of the switch 40. “PS” represents a voltage level at the terminal PS. “SWL” represents a voltage level at the terminal SWL. “Vbattery” represents a voltage (battery output voltage) between the terminal P+ and the terminal P−. A normal mode is also referred to as a normal state. A power save mode is also referred to as a forced shut-down state.

In the normal mode, the control circuit 21 of the protection IC 201 turns the charge control transistor 1 and the discharge control transistor 2 on. When the discharge control transistor 2 is turned on, a battery output voltage Vbattery is substantially equal to a cell voltage Vcell of the secondary battery 70. In the normal mode, the control circuit 21 connects the terminal SWL to the terminal VDD, but the terminal SWL may be an open output terminal.

When a predetermined condition is satisfied, the system circuit 41 of the electronic device 301 outputs a forced shut-down signal at a high level from the terminal GPIO. That is, the system circuit 41 continuously outputs a forced shut-down signal at a high level from the terminal GPIO while the predetermined condition is being satisfied.

In the normal mode, in a state of the potential level of the terminal PS being changed from a first level (in this example, a potential level that is substantially the same potential level as the terminal VSS), the control circuit 21 switches the operation mode of the protection IC 201 from the normal mode to the power save mode. The control circuit 21 switches the operation mode of the protection IC 201 from the normal mode to the power save mode when, for example, a state where the potential level of the terminal PS is increased and is higher than a first threshold value Vps_det continues for a predetermined time (delay time d1) or longer.

The power save mode is a discharge blocked state in which the discharge control transistor 2 is turned off and the terminal SWL and the terminal VSS are connected to each other by turning the internal switch 31 on. Since the battery output voltage Vbattery becomes substantially zero by turning the discharge control transistor 2 off, the system circuit 41 is shut down and the terminal GPIO that outputs the forced shut-down signal has high impedance (Hi Z). Since the battery output voltage Vbattery becomes substantially zero, the consumption current of the electronic device 301 is reduced. In the power save mode, the control circuit 21 blocks the power supply to the abnormality detection circuit 20. By blocking the power supply to the abnormality detection circuit 20, the current consumption of the protection IC 201 is reduced.

Since the terminal SWL and the terminal VSS are connected to each other by turning the internal switch 31 on, the potential at the terminal SWL is substantially the same as the potential at the terminal VSS and at the negative electrode 72. Accordingly, the potential at a first end of the switch 40 is substantially the same as the potential at the terminal VSS and at the negative electrode 72. Additionally, when the discharge control transistor 2 is turned off, the potential at the terminal P− is substantially the same as the potential at the terminal P+ and at the positive electrode 71 due to the presence of the external circuit 340. Accordingly, the potential at the terminal PS and the potential at a second end of the switch 40 are substantially the same as the potential at the terminal P+ and at the positive electrode 71.

When the switch 40 is turned on in the power save mode, the potential level of the terminal PS is changed from a second level that is different from the first level to a third level. In this example, the second level is a potential level that is substantially the same as that of the terminal P+ and the positive electrode 71, and the third level is a potential level lower than the second level. In this example, the third level corresponds to a potential level obtained by dividing the cell voltage Vcell by the resistance element Rpu, the resistance element Rpd, and the internal resistor 32. The resistance element Rpu has a resistance value sufficiently larger than those of the internal resistor 32 and the resistance element Rpd. Note that the resistance element Rpu may be a transistor such as a MOSFET as long as it is a conductive element having a resistance value.

In the power save mode, when a state where the potential level of the terminal PS is decreased and is lower than a second threshold value Vps_rel continues for a predetermined time (delay time d2) or longer, the control circuit 21 switches (returns) the operation mode of the protection IC 201 from the power save mode to the normal mode.

Once the mode is returned to the normal mode, the control circuit 21 turns the discharge control transistor 2 on and blocks the connection between the terminal SWL and the terminal VSS by turning the internal switch 31 off. The control circuit 21 also connects the terminal SWL to the terminal VDD, but the terminal SWL may be an open output terminal.

As described above, in the first embodiment, in a state of the potential level of the input terminal PS being changed from the first level, the control circuit 21 turns the discharge control transistor 2 off and enables the discharge blocked state in which the output terminal SWL and the terminal VSS are connected to each other. In a state of the potential level of the terminal PS being changed from the second level in the discharge blocked state, the control circuit 21 turns the discharge control transistor 2 on. Since the power supply of the system circuit 41 is blocked by turning the discharge control transistor 2 off in the discharge blocked state, the system circuit 41 cannot detect that the switch 40 is turned on and cannot output a control signal to cancel the power save mode.

However, in the first embodiment, since the output terminal SWL and the terminal VSS are connected to each other in the discharge blocked state, the potential at the first end of the switch 40 can be set to be substantially the same as the potential at the terminal VSS and at the negative electrode 72. Therefore, in the discharge blocked state, since the potential level of the terminal PS is changed as the switch 40 is turned on, the control circuit 21 can detect that the switch 40 is turned on, thereby turning the discharge control transistor 2 on. That is, since the power save mode is canceled by turning the switch 40 on without connecting the charger, the convenience of canceling the powered-down state is therefore improved.

Note that, in the first embodiment, the terminal VSS is an example of a first power supply terminal, the terminal VDD is an example of a second power supply terminal, the negative electrode 72 is an example of a first electrode, the positive electrode 71 is an example of a second electrode, and the negative-side current path 5 is an example of a discharge path that is connected to the first electrode. Furthermore, in the first embodiment, the terminal PS is an example of an input terminal, and the terminal SWL is an example of an output terminal.

### Second Embodiment

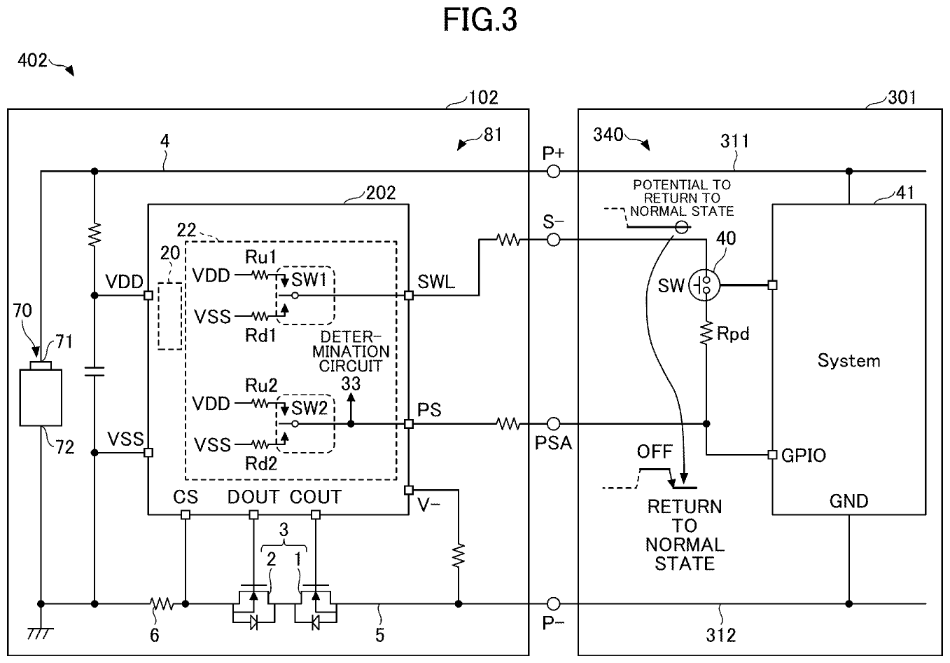

FIG. 3 is a diagram illustrating an example of the configuration of a power supply system according to a second embodiment. In the second embodiment, the description of the same configurations, actions, and effects as those of the first embodiment will be omitted or simplified by referring to the above description. The second embodiment is different from the first embodiment in that, the resistance element Rpu is not externally connected to the terminal PS, and an internal resistor Ru2 having the same function as the resistance element Rpu in the first embodiment is incorporated in the secondary battery protection integrated circuit.

A power supply system 402 illustrated in FIG. 3 includes a battery device 102. The battery device 102 includes a battery protection circuit 81. The battery protection circuit 81 includes a terminal P+, a terminal P−, a terminal S−, a terminal PSA, a switching circuit 3, and a protection IC 202.

The protection IC 202 is an example of a secondary battery protection integrated circuit. The protection IC 202 includes an abnormality detection circuit 20 and a control circuit 22. The control circuit 22 includes a switch control circuit that turns a charge control transistor 1 or a discharge control transistor 2 of the switching circuit 3 on or off based on the abnormality detection result detected by the abnormality detection circuit 20. The control circuit 22 includes an internal switch SW1, an internal switch SW2, and a determination circuit 33.

The internal switch SW1 switches between connection and disconnection between a terminal SWL and a terminal VSS, and switches between connection and disconnection between the terminal SWL and a terminal VDD. In this example, the internal switch SW1 switches between connection between the terminal SWL and the terminal VSS via an internal resistor Rd1 and connection between the terminal SWL and the terminal VDD via an internal resistor Ru1 or turns the terminal SWL into an open output terminal.

The internal switch SW2 switches between connection and disconnection between the terminal PS and the terminal VSS and switches between connection and disconnection between the terminal PS and the terminal VDD. In this example, the internal switch SW2 switches between connection between the terminal PS and the terminal VSS via an internal resistor Rd2 and connection between the terminal PS and the terminal VDD via the internal resistor Ru2 or turns the terminal PS into an open output terminal.

The determination circuit 33 controls switching operations of the internal switch SW1 and the internal switch SW2 according to the potential level of the terminal PS.

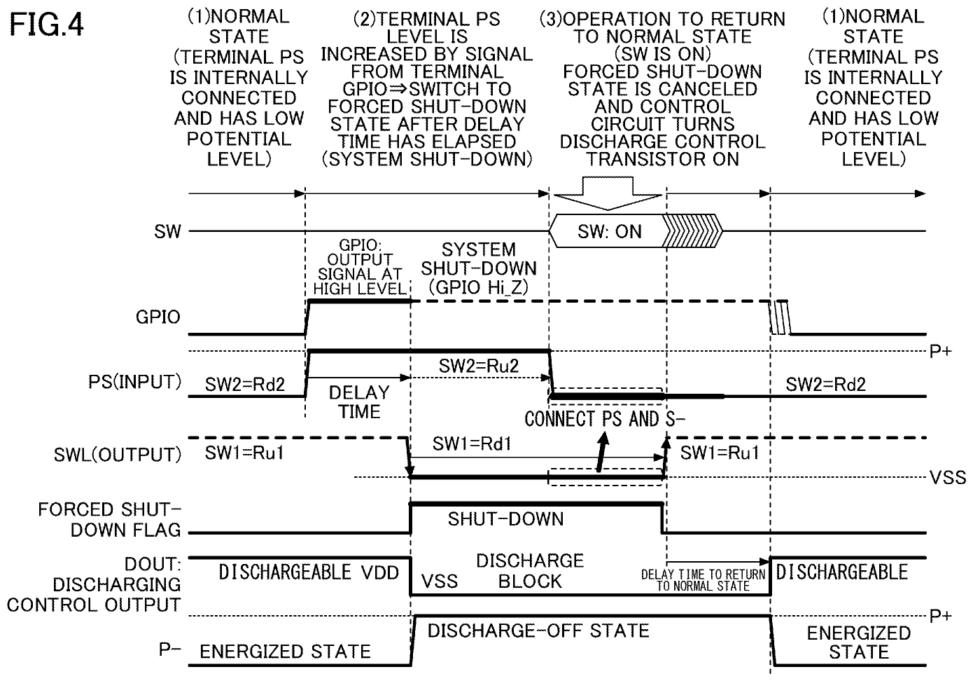

FIG. 4 is a timing chart illustrating an operation example of the power supply system according to the second embodiment. FIG. 4 illustrates operation mode transition of the protection IC 202. FIG. 4 will now be described with reference to FIG. 3.

In FIG. 4, “SW” represents an on-state or off-state of the switch 40. “GPIO” represents a voltage level at a terminal GPIO. “PS (input)” represents a voltage level at the terminal PS. “SWL (output)” represents a voltage level at the terminal SWL. “Forced shut-down flag” represents information whether the control circuit 22 sets the operation mode of the protection IC 202 to the power save mode. “DOUT: Discharging control output” represents a voltage level at a terminal DOUT. “P−” represents a potential level of the terminal P−.

The control circuit 22 of the protection IC 202 turns the charge control transistor 1 and the discharge control transistor 2 on in the normal mode. Since the discharge control transistor 2 is turned on, the potential level of the terminal P− is substantially the same as that of a negative electrode 72, and the battery output is in an energized state. In the normal mode, the control circuit 22 connects the terminal SWL to the terminal VDD (SW1=Ru1), but the terminal SWL may be an open output terminal. In the normal mode, the control circuit 22 also connects the terminal PS to the terminal VSS (SW2=Rd2).

When a predetermined condition is satisfied, a system circuit 41 of an electronic device 301 outputs a forced shut-down signal at a high level from the terminal GPIO. The system circuit 41 continuously outputs a forced shut-down signal at a high level from the terminal GPIO while the predetermined condition is being satisfied.

In the normal mode, in a state of the potential level of the terminal PS being changed from a first level (in this example, a potential level that is substantially the same as that of the terminal VSS), the control circuit 22 switches the operation mode of the protection IC 202 from the normal mode to the power save mode. The control circuit 22 switches the operation mode of the protection IC 202 from the normal mode to the power save mode when, for example, a state where the potential level of the terminal PS is increased and is higher than a first threshold value Vps_det continues for a predetermined time (delay time d1) or longer.

The power save mode is a discharge blocked state in which the discharge control transistor 2 is turned off, the terminal SWL and the terminal VSS are connected by turning the internal switch SW1 (SW1=Rd1) on, and the terminal PS and the terminal VDD are connected by turning the internal switch SW2 (SW2=Ru2) on. Since the battery output is in a discharge-off state by turning the discharge control transistor 2 off, the system circuit 41 is shut down and the terminal GPIO that outputs the forced shut-down signal has high impedance (Hi Z). Since the battery output is in the discharge-off state, the consumption current of the electronic device 301 is reduced. In the power save mode, the control circuit 22 blocks the power supply to the abnormality detection circuit 20. By blocking the power supply of the abnormality detection circuit 20, the current consumption of the protection IC 202 is reduced.

Since the terminal SWL and the terminal VSS are connected to each other by turning the internal switch SW1 (SW1=Rd1) on, the potential at the terminal SWL is substantially the same as the potential at the terminal VSS and at the negative electrode 72. Accordingly, the potential at a first end of the switch 40 is substantially the same as the potential at the terminal VSS and at the negative electrode 72. In contrast, since the terminal PS and the terminal VDD are connected to each other by turning the internal switch SW2 (SW2=Ru2) on, the potential at the terminal PS is substantially the same as the potential at the terminal P+ and at a positive electrode 71. Accordingly, the potential at a second end of the switch 40 is substantially the same as the potential at the terminal P+ and at the positive electrode 71.

When the switch 40 is turned on in the power save mode, the potential level of the terminal PS is changed from a second level that is different from the first level to a third level. In this example, the second level is a potential level that is substantially the same as that of the terminal P+ and the positive electrode 71, and the third level is a potential level that is lower than the second level. In this example, the third level corresponds to a potential level obtained by dividing a cell voltage Vcell by the internal resistor Ru2, a resistance element Rpd, and the internal resistor Ru1. The resistance value of the internal resistor Ru2 is sufficiently larger than those of the internal resistor Rd1 and the resistance element Rpd.

In the power save mode, when a state where the potential level of the terminal PS is decreased and is lower than a second threshold value Vps_rel continues for a predetermined time (delay time d2) or longer, the control circuit 22 switches (returns) the operation mode of the protection IC 202 from the power save mode to the normal mode. The control circuit 22 also connects the terminal PS to the terminal VSS (SW=Rd2), but the terminal PS may be an open output terminal.

As described above, in the second embodiment, since the output terminal SWL and the terminal VSS are connected to each other in the discharge blocked state, the potential at the first end of the switch 40 can be set to be substantially the same as the potential at the terminal VSS and at the negative electrode 72. Therefore, in the discharge blocked state, since the potential level of the terminal PS is changed as the switch 40 is turned on, the control circuit 22 can detect that the switch 40 is turned on, thereby turning the discharge control transistor 2 on. That is, since the power save mode is canceled by turning the switch 40 on without connecting the charger, the convenience of canceling the powered-down state is therefore improved.

Note that, in the second embodiment, the terminal VSS is an example of a first power supply terminal, the terminal VDD is an example of a second power supply terminal, the negative electrode 72 is an example of a first electrode, the positive electrode 71 is an example of a second electrode, and the negative-side current path 5 is an example of a discharge path that is connected to the first electrode. In the second embodiment, the terminal PS is an example of an input terminal, and the terminal SWL is an example of an output terminal.

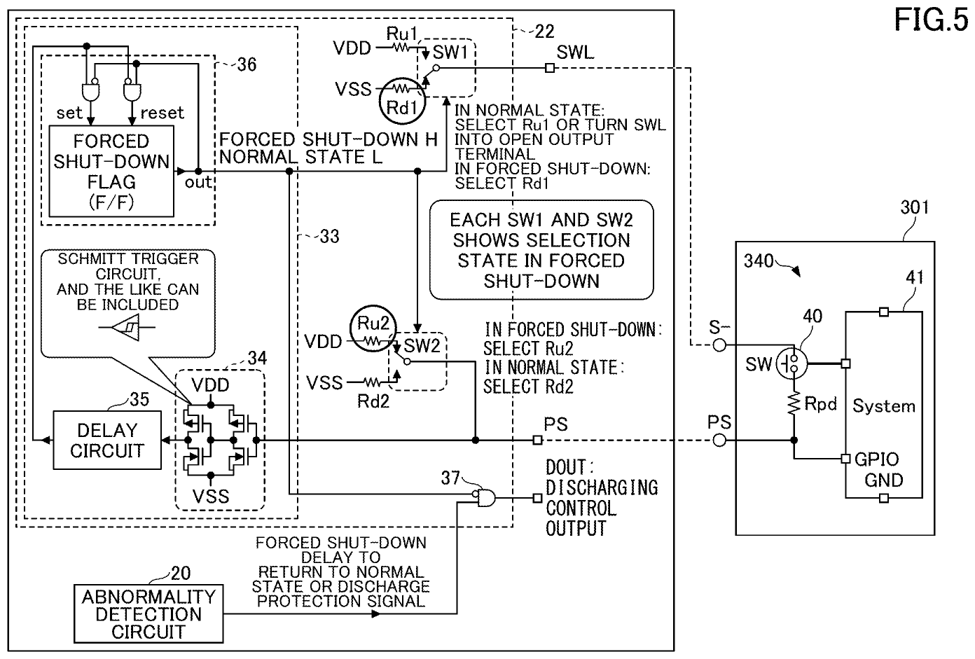

FIG. 5 is a diagram illustrating an example of the configuration of the control circuit in the secondary battery protection integrated circuit according to the second embodiment. The control circuit 22 illustrated in FIG. 5 includes the determination circuit 33 that controls switching operations of the internal switch SW1 and the internal switch SW2 according to the potential level of the terminal PS. The determination circuit 33 includes a Schmitt trigger circuit 34, a delay circuit 35, a shut-down setting circuit 36, and a logic circuit 37.

The Schmitt trigger circuit 34 detects a change in the potential level of the terminal PS. The delay circuit 35 delays a detection signal indicating that the potential level of the terminal PS has been changed output from the Schmitt trigger circuit 34, and then supplies the detection signal to the shut-down setting circuit 36. The shut-down setting circuit 36 includes a logic circuit and a flip-flop circuit (F/F). When it is determined that the forced shut-down signal is input to the terminal PS, the shut-down setting circuit 36 outputs a flag signal at a high level (H). In contrast, the shut-down setting circuit 36 outputs a flag signal of a low level (L) when it is determined that a release signal for canceling the power save mode generated by turning the switch 40 on is input to the terminal PS. The control circuit 22 controls switching of the internal switch SW1 and the internal switch SW2 in accordance with the flag signal output from the shut-down setting circuit 36. The control circuit 22 includes a logic circuit 37 that sets the level at the terminal DOUT to a high level or a low level in accordance with the flag signal output from the shut-down setting circuit 36 and the abnormality detection signal output from the abnormality detection circuit 20. By having such a configuration, the control circuit 22 achieves the operation illustrated in FIG. 4.

### Third Embodiment

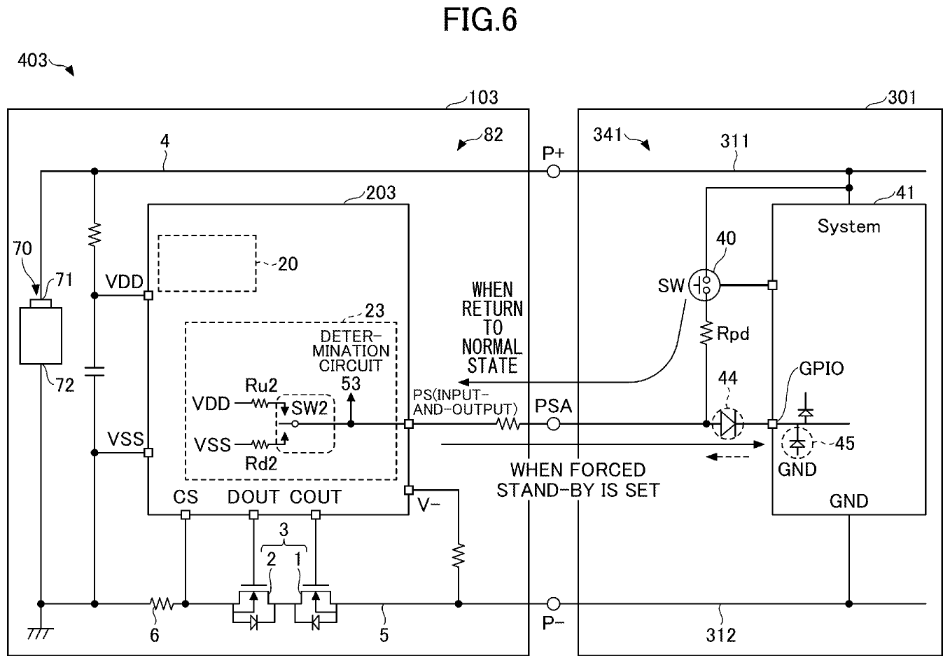

FIG. 6 is a diagram illustrating an example of the configuration of a power supply system according to a third embodiment. In the third embodiment, the description of the same configurations, actions, and effects as those of the above-described embodiments will be omitted or simplified by incorporating the above description. The third embodiment is different from the second embodiment in that the terminal PS and the terminal SWL are integrated into a single input-and-output terminal (terminal PS).

A power supply system 403 illustrated in FIG. 6 includes a battery device 103 and an external circuit 341. The external circuit 341 is provided in an electronic device 301.

The battery device 103 includes a battery protection circuit 82. The battery protection circuit 82 includes a terminal P+, a terminal P−, a terminal PSA, a switching circuit 3, and a protection IC 203.

The protection IC 203 is an example of a secondary battery protection integrated circuit. The protection IC 203 includes an abnormality detection circuit 20 and a control circuit 23. The control circuit 23 includes a switch control circuit that turns a charge control transistor 1 or a discharge control transistor 2 of the switching circuit 3 on or off based on the abnormality detection result detected by the abnormality detection circuit 20. The control circuit 23 includes an internal switch SW2 and a determination circuit 53.

The determination circuit 53 controls the switching operation of the internal switch SW2 according to the potential level of the terminal PS.

The external circuit 341 includes a resistance element Rpd, a switch 40, a system circuit 41, and a diode 44. The external circuit 341 is, for example, a power supply circuit for the electronic device 301.

The switch 40 is provided outside the protection IC 203 and switches between connection and disconnection between the terminal PS and a power line 311. In this example, the switch 40 is provided outside the battery device 103. A series circuit in which the switch 40 and the resistance element Rpd are connected in series is inserted between the terminal P+ and the terminal PSA.

The diode 44 is an element connected between a terminal GPIO and the terminal PSA. The diode 44 has an anode connected to the terminal PSA and a cathode connected to the terminal GPIO. The anode of the diode 44 is connected between the terminal PS and the switch 40. The diode 44 is an example of a backflow prevention device that prevents a current from flowing through a diode existing outside the protection IC 203. In this example, the diode 44 prevents a current from flowing backward from a ground line 312 to the terminal PS via a parasitic diode 45. The parasitic diode 45 is present between the ground line 312 and the terminal GPIO. When the discharge control transistor 2 is in the off-state, the potential at the ground line 312 is increased to the potential at the terminal P+ and at a positive electrode 71, and thus the diode 44 prevents a current from flowing backward through the parasitic diode 45 and an internal resistor Rd2. The diode outside the protection IC 203 is not limited to the parasitic diode 45, and may be a protection diode that is connected between the ground line 312 and the terminal GPIO.

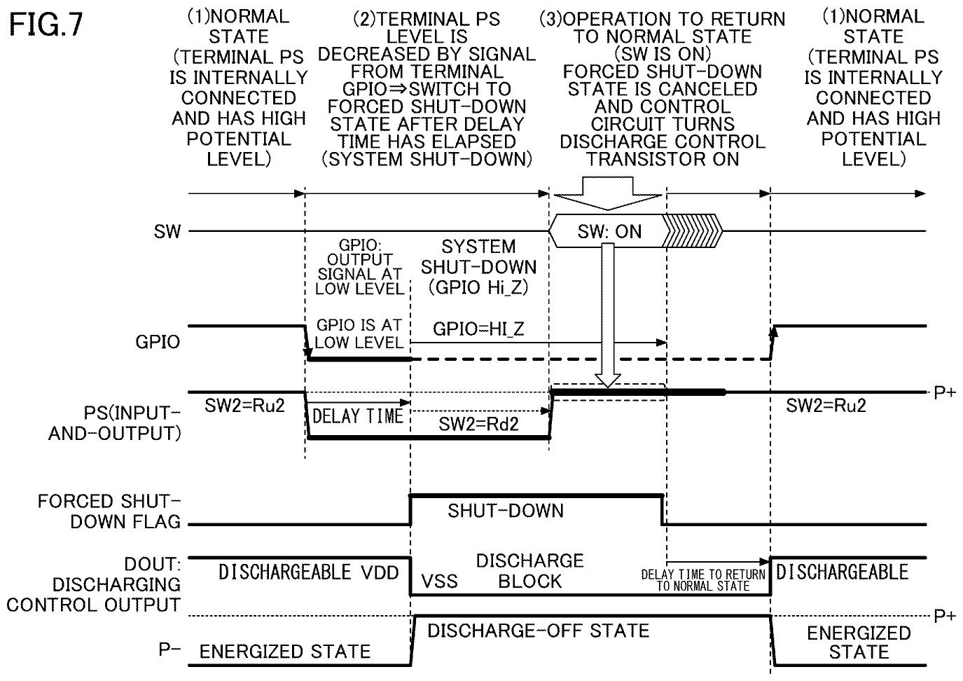

FIG. 7 is a timing chart illustrating an operation example of the power supply system according to the third embodiment. FIG. 7 illustrates operation mode transition of the protection IC 203. FIG. 7 will now be described with reference to FIG. 6.

In FIG. 7, “PS (input-and-output)” represents a voltage level at the terminal PS. The other labels are the same as in FIG. 4.

The control circuit 23 of the protection IC 203 turns the charge control transistor 1 and the discharge control transistor 2 on in the normal mode. When the discharge control transistor 2 is turned on, the potential level of the terminal P− is substantially the same as that of the negative electrode 72, and the battery output is in an energized state. In the normal mode, the control circuit 23 connects the terminal PS to a terminal VDD (SW2=Ru2).

When a predetermined condition is satisfied, the system circuit 41 of the electronic device 301 outputs a forced shut-down signal at a low level from the terminal GPIO. The system circuit 41 continuously outputs a forced shut-down signal at a low level from the terminal GPIO while the predetermined condition is being satisfied.

In the normal mode, in a state the potential level of the terminal PS being changed from a first level (in this example, a potential level that is substantially the same as that of the terminal VDD), the control circuit 23 switches the operation mode of the protection IC 203 from the normal mode to the power save mode. The control circuit 23 switches the operation mode of the protection IC 203 from the normal mode to the power save mode when, for example, a state in which the potential level of the terminal PS is decreased and is lower than a first threshold value Vps_det continues for a predetermined time (delay time d1) or longer.

The power save mode is a discharge blocked state in which the discharge control transistor 2 is turned off, and the terminal PS and a terminal VSS are connected by turning the internal switch SW2 (SW2=Rd2) on. Since the battery output is in a discharge-off state by turning the discharge control transistor 2 off, the system circuit 41 is shut-down and the terminal GPIO that outputs the forced shut-down signal has high impedance (Hi Z). Since the battery output is in the discharge-off state, the consumption current of the electronic device 301 is reduced. In the power save mode, the control circuit 23 blocks the power supply to the abnormality detection circuit 20. By blocking the power supply of the abnormality detection circuit 20, the current consumption of the protection IC 203 is reduced.

Since the terminal PS and the terminal VSS are connected to each other by turning the internal switch SW2 (SW2=Rd2) on, the potential at the terminal PS is substantially the same as the potential at the terminal B− and at the negative electrode 72. Thus, the potential at a second end of the switch 40 is substantially the same as the potential at the terminal B− and at the negative electrode 72.

When the switch 40 is turned on in the power save mode, the potential level of the terminal PS is changed from a second level that is different from the first level to a third level. In this example, the second level is a potential level that is substantially the same as that of the terminal B− and the negative electrode 72, and the third level is a potential level that is higher than the second level. In this example, the third level corresponds to a potential level obtained by dividing a cell voltage Vcell by the internal resistor Rd2 and the resistance element Rpd. The resistance value of the internal resistor Rd2 is sufficiently larger than that of the resistance element Rpd.

In the power save mode, the control circuit 23 switches (returns) the operation mode of the protection IC 203 from the power save mode to the normal mode when a state where the potential level of the terminal PS is increased and is higher than a second threshold value Vps_rel continues for a predetermined time (delay time d2) or longer.

Once the mode is returned to the normal mode, the control circuit 23 turns the discharge control transistor 2 on and blocks the connection between the terminal PS and the terminal VSS by turning the internal switch SW2 off. The control circuit 23 also connects the terminal PS to the terminal VDD (SW2=Ru2), but the terminal PS may be an open output terminal.

As described above, in the third embodiment, since the terminal PS and the terminal VSS are connected to each other in the discharge blocked state, the potential at a first end of the switch 40 can be set to be substantially the same as the potential at the terminal VSS and at the negative electrode 72. Therefore, in the discharge blocked state, since the potential level of the terminal PS is changed as the switch 40 is turned on, the control circuit 23 can detect that the switch 40 is turned on, thereby turning the discharge control transistor 2 on. That is, since the power save mode is canceled by turning the switch 40 on without connecting the charger, the convenience of canceling the powered-down state is therefore improved.

Note that, in the third embodiment, the terminal VSS is an example of a first power supply terminal, the terminal VDD is an example of a second power supply terminal, the negative electrode 72 is an example of a first electrode, the positive electrode 71 is an example of a second electrode, and the negative-side current path 5 is an example of a discharge path that is connected to the first electrode. Furthermore, in the third embodiment, the terminal PS is an example of an input-and-output terminal, and the power line 311 is an example of a second discharge path that is connected to the second electrode.

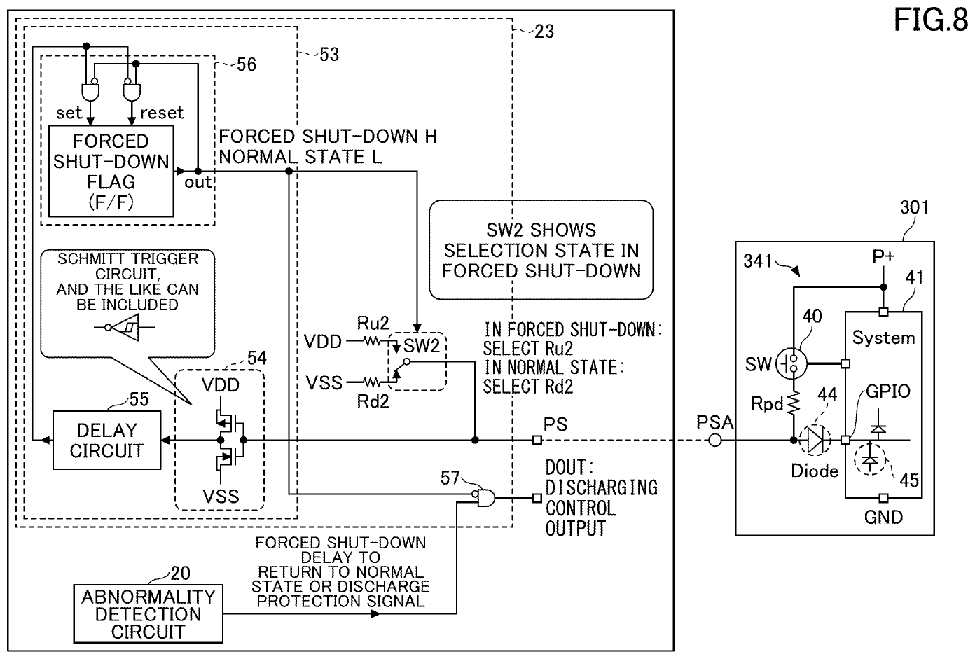

FIG. 8 is a diagram illustrating an example of the configuration of the control circuit in the secondary battery protection integrated circuit according to the third embodiment. The control circuit 23 illustrated in FIG. 8 includes the determination circuit 53 that controls a switching operation of the internal switch SW2 according to the potential level of the terminal PS. The determination circuit 53 includes a Schmitt trigger circuit 54, a delay circuit 55, a shut-down setting circuit 56, and a logic circuit 57. The functions of the Schmitt trigger circuit 54, the delay circuit 55, the shut-down setting circuit 56, and the logic circuit 57 may be similar to the above-described functions of the Schmitt trigger circuit 34, the delay circuit 35, the shut-down setting circuit 36, and the logic circuit 37. By having such a configuration, the control circuit 23 achieves the operation illustrated in FIG. 7.

### Fourth Embodiment

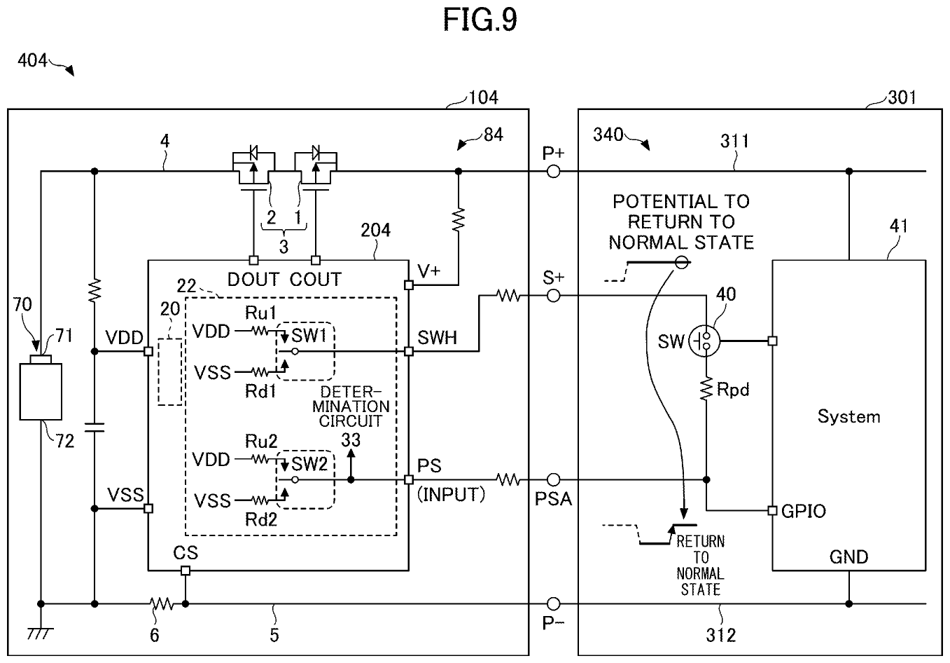

FIG. 9 is a diagram illustrating an example of the configuration of a power supply system according to a fourth embodiment. In the fourth embodiment, description of the same configurations, operations, and effects as those of the above-described embodiments will be omitted or simplified by referring to the above description. The fourth embodiment is different from the second embodiment in that the switching circuit 3 is inserted in series into a positive-side current path 4.

A power supply system 404 illustrated in FIG. 9 includes a battery device 104. The battery device 104 includes a battery protection circuit 84. The battery protection circuit 84 includes a terminal P+, a terminal P−, a terminal S+, a terminal PSA, a switching circuit 3, and a protection IC 204. Each of a charge control transistor 1 and a discharge control transistor 2 is, for example, a P-channel MOSFET.

The protection IC 204 is an example of a secondary battery protection integrated circuit. The protection IC 204 includes an abnormality detection circuit 20 and a control circuit 22. The control circuit 22 includes a switch control circuit that turns the charge control transistor 1 or the discharge control transistor 2 of the switching circuit 3 on or off based on the abnormality detection result detected by the abnormality detection circuit 20. The control circuit 22 includes an internal switch SW1, an internal switch SW2, and a determination circuit 33.

The protection IC 204 includes, for example, a charging control terminal (terminal COUT), a discharging control terminal (terminal DOUT), a monitoring terminal (terminal V+), a power supply terminal (terminal VDD), a ground terminal (terminal VSS), a current detection terminal (terminal CS), an input terminal (terminal PS), and an output terminal (terminal SWH). These terminals are external connection terminals that are used to connect an internal circuit of the protection IC 204 to the outside of the protection IC 204.

The terminal V+ is connected to the terminal P+ to monitor the potential at the terminal P+. The terminal V+ is used by a detection circuit within the protection IC 204 to, for example, monitor the presence or absence of a connection with an electronic device 301 or the charger. The terminal V+ is connected to a node in the positive-side current path 4 between the switching circuit 3 and the terminal P+.

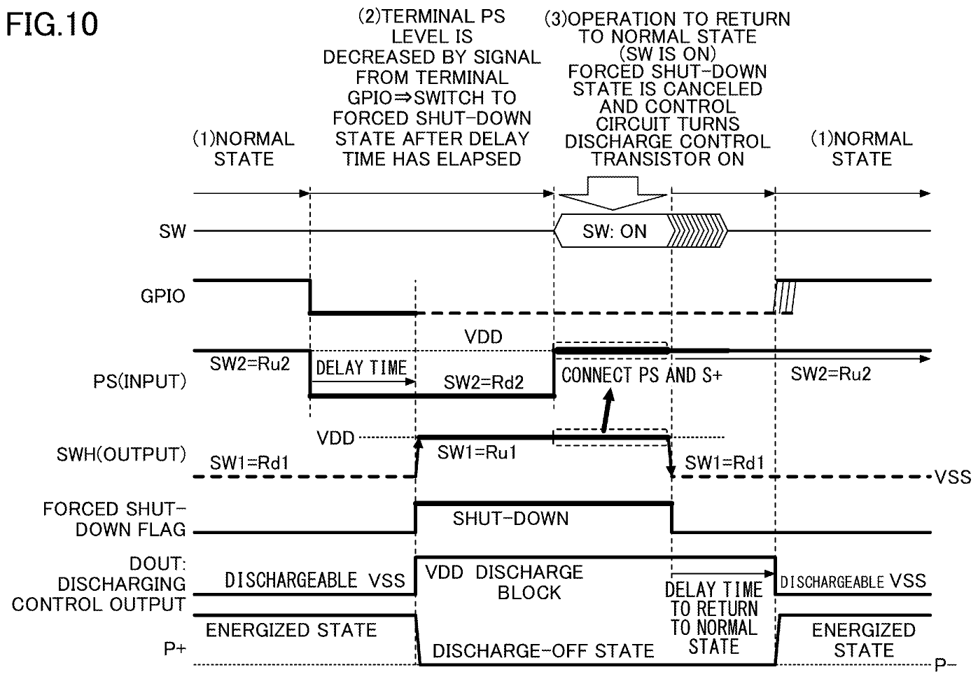

FIG. 10 is a timing chart illustrating an operation example of the power supply system according to the fourth embodiment. FIG. 10 illustrates operation mode transition of the protection IC 204. FIG. 10 will now be described with reference to FIG. 9.

In FIG. 10, “P+” represents the potential level of the terminal P+. The other labels are the same as in FIG. 4.

The control circuit 22 of the protection IC 204 turns the charge control transistor 1 and the discharge control transistor 2 on in the normal mode. Since the discharge control transistor 2 is turned on, the potential level of the terminal P+ is substantially the same as that of a positive electrode 71, and the battery output is in an energized state. In the normal mode, the control circuit 22 connects the terminal SWH to the terminal VSS (SW1=Rd1), but the terminal SWH may be an open output terminal. In the normal mode, the control circuit 22 also connects the terminal PS to a terminal VDD (SW2=Ru2).

When a predetermined condition is satisfied, the system circuit 41 of the electronic device 301 outputs a forced shut-down signal at a low level from a terminal GPIO. The system circuit 41 continuously outputs a forced shut-down signal at a low level from the terminal GPIO while the predetermined condition is being satisfied.

In the normal mode, in a state of the potential level of the terminal PS being changed from a first level (in this example, a potential level that is substantially the same as that of the terminal VDD), the control circuit 22 switches the operation mode of the protection IC 204 from the normal mode to the power save mode. The control circuit 22 switches the operation mode of the protection IC 204 from the normal mode to the power save mode when, for example, a state in which the potential level of the terminal PS is decreased and is lower than a first threshold value Vps_det continues for a predetermined time (delay time d1) or longer.

The power save mode is a discharge blocked state in which the discharge control transistor 2 is turned off, the terminal SWH and the terminal VDD are connected by turning the internal switch SW1 (SW1=Ru1) on, and the terminal PS and the terminal VSS are connected by turning the internal switch SW2 (SW2=Rd2) on. Since the battery output is in a discharge-off state by turning the discharge control transistor 2 off, the system circuit 41 is shut down and the terminal GPIO that outputs the forced shut-down signal has high impedance (Hi Z). Since the battery output is in the discharge-off state, the consumption current of the electronic device 301 is reduced. In the power save mode, the control circuit 22 blocks the power supply to the abnormality detection circuit 20. By blocking the power supply of the abnormality detection circuit 20, the current consumption of the protection IC 204 is reduced.

Since the terminal SWH and the terminal VDD are connected to each other by turning the internal switch SW1 (SW1=Ru1) on, the potential at the terminal SWH is substantially the same as the potential at the terminal VDD and at the positive electrode 71. Accordingly, the potential at a first end of the switch 40 is substantially the same as the potential at the terminal VDD and at the positive electrode 71. In contrast, since the terminal PS and the terminal VSS are connected to each other by turning the internal switch SW2 (SW2=Rd2) on, the potential at the terminal PS is substantially the same as the potential at the terminal P− and at a negative electrode 72. Accordingly, the potential at a second end of the switch 40 is substantially the same as the potential at the terminal P− and at the negative electrode 72.

When the switch 40 is turned on in the power save mode, the potential level of the terminal PS is changed from a second level that is different from the first level to a third level. In this example, the second level is a potential level that is substantially the same as that of the terminal P− and the negative electrode 72, and the third level is a potential level higher than the second level. In this example, the third level corresponds to a potential level obtained by dividing a cell voltage Vcell by an internal resistor Ru1, a resistance element Rpd, and an internal resistor Rd2. The internal resistor Rd2 has a resistance value sufficiently larger than those of the internal resistor Ru1 and the resistance element Rpd.

In the power save mode, when a state where the potential level of the terminal PS is increased and is higher than a second threshold value Vps_rel continues for a predetermined time (delay time d2) or longer, the control circuit 22 switches (returns) the operation mode of the protection IC 204 from the power save mode to the normal mode. The control circuit 22 also connects the terminal PS to the terminal VDD (SW2=Ru2), but the terminal PS may be an open output terminal.

As described above, in the fourth embodiment, since the output terminal SWH and the terminal VDD are connected to each other in the discharge blocked state, the potential at the first end of the switch 40 can be set to be substantially the same as the potential at the terminal VDD and at the positive electrode 71. Therefore, in the discharge blocked state, since the potential level of the terminal PS is changed as the switch 40 is turned on, the control circuit 22 can detect that the switch 40 is turned on, thereby turning the discharge control transistor 2 on. That is, since the power save mode is canceled by turning the switch 40 on without connecting the charger, the convenience of canceling the powered-down state is therefore improved.

Note that, in the fourth embodiment, the terminal VDD is an example of a first power supply terminal, the terminal VSS is an example of a second power supply terminal, the positive electrode 71 is an example of a first electrode, the negative electrode 72 is an example of a second electrode, and the positive-side current path 4 is an example of a discharge path that is connected to the first electrode. Furthermore, in the fourth embodiment, the terminal PS is an example of an input terminal, and the terminal SWH is an example of an output terminal.

### Fifth Embodiment

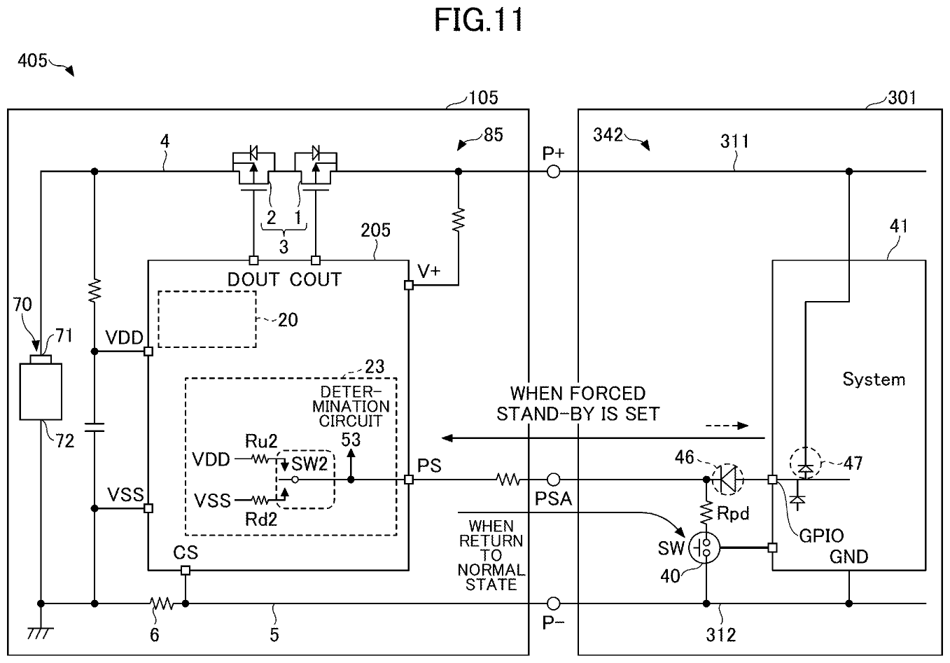

FIG. 11 is a diagram illustrating an example of the configuration of a power supply system according to a fifth embodiment. In the fifth embodiment, the description of the same configurations, actions, and effects as those of the above-described embodiments will be omitted or simplified by referring to the above description. The fifth embodiment is different from the fourth embodiment in that the terminal PS and the terminal SWH are integrated into a single input-and-output terminal (terminal PS).

A power supply system 405 illustrated in FIG. 11 includes a battery device 105 and an external circuit 342. The external circuit 342 is provided in an electronic device 301.

The battery device 105 includes a battery protection circuit 85. The battery protection circuit 85 includes a terminal P+, a terminal P−, a terminal PSA, a switching circuit 3, and a protection IC 205.

The protection IC 205 is an example of a secondary battery protection integrated circuit. The protection IC 205 includes an abnormality detection circuit 20 and a control circuit 23. The control circuit 23 includes a switch control circuit that turns a charge control transistor 1 or a discharge control transistor 2 of the switching circuit 3 on or off based on the abnormality detection result detected by the abnormality detection circuit 20. The control circuit 23 includes an internal switch SW2 and a determination circuit 53.

The determination circuit 53 controls the switching operation of the internal switch SW2 according to the potential level of the terminal PS.

The external circuit 342 includes a resistance element Rpd, a switch 40, a system circuit 41, and a diode 46. The external circuit 342 is, for example, a power supply circuit of the electronic device 301.

The switch 40 is provided outside the protection IC 205 and switches between connection and disconnection between the terminal PS and a ground line 312. In this example, the switch 40 is provided outside the battery device 105. A series circuit in which the switch 40 and the resistance element Rpd are connected in series is inserted between the terminal P− and the terminal PSA.

The diode 46 is an element connected between a terminal GPIO and the terminal PSA. The diode 46 has a cathode connected to the terminal PSA and an anode connected to the terminal GPIO. The cathode of the diode 46 is connected to a node between the terminal PS and the switch 40. The diode 46 is an example of a backflow prevention device that prevents a current from flowing through a diode existing outside the protection IC 205. The diode 46 prevents a current from flowing backward from the terminal PS to a power line 311 via a parasitic diode 47. The parasitic diode 47 is present between the power line 311 and the terminal GPIO. When the discharge control transistor 2 is in the off-state, the potential at the power line 311 is decreased to the potential at the terminal P− and at a negative electrode 72, and thus the diode 46 prevents a current from flowing backward through an internal resistor Ru2 and the parasitic diode 47. The diode outside the protection IC 205 is not limited to the parasitic diode 47, and may be a protection diode that is connected between the power line 311 and the terminal GPIO.

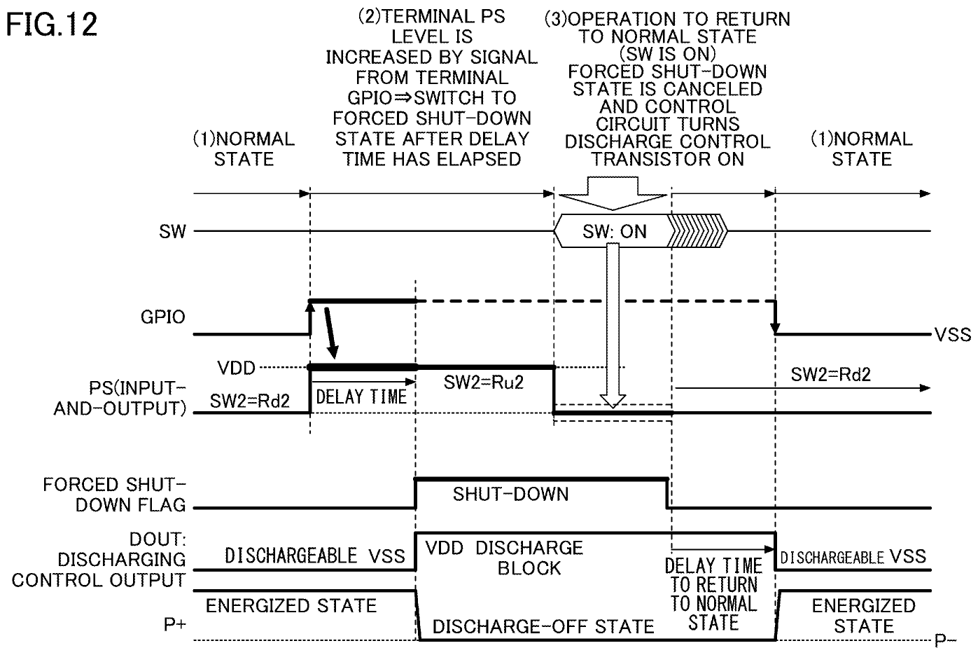

FIG. 12 is a timing chart illustrating an operation example of the power supply system according to the fifth embodiment. FIG. 12 illustrates operation mode transition of the protection IC 205. FIG. 12 will now be described with reference to FIG. 11.

In FIG. 12, “P+” represents the potential level of the terminal P+. The other labels are the same as in FIG. 7.

The control circuit 23 of the protection IC 205 turns the charge control transistor 1 and the discharge control transistor 2 on in the normal mode. When the discharge control transistor 2 is turned on, the potential level of the terminal P+ is substantially the same as that of the positive electrode 71, and the battery output is in an energized state. In the normal mode, the control circuit 23 connects the terminal PS to a terminal VSS (SW2=Rd2).

When a predetermined condition is satisfied, the system circuit 41 of the electronic device 301 outputs a forced shut-down signal at a high level from the terminal GPIO. The system circuit 41 continuously outputs a forced shut-down signal at a high level from the terminal GPIO while the predetermined condition is being satisfied.

In the normal mode, in a state of the potential level of the terminal PS being changed from a first level (in this example, a potential level that is substantially the same as that of the terminal VSS), the control circuit 23 switches the operation mode of the protection IC 205 from the normal mode to the power save mode. The control circuit 23 switches the operation mode of the protection IC 205 from the normal mode to the power save mode when, for example, a state in which the potential level of the terminal PS is increased and is lower than a first threshold value Vps_det continues for a predetermined time (delay time d1) or longer.

The power save mode is a discharge blocked state in which the discharge control transistor 2 is turned off, and the terminal PS and a terminal VDD are connected by turning the internal switch SW2 (SW2=Ru2) on. Since the battery output is in a discharge-off state by turning the discharge control transistor 2 off, the system circuit 41 is shut down and the terminal GPIO that outputs the forced shut-down signal has high impedance (Hi Z). Since the battery output is in the discharge-off state, the consumption current of the electronic device 301 is reduced. In the power save mode, the control circuit 23 blocks the power supply to the abnormality detection circuit 20. By blocking the power supply of the abnormality detection circuit 20, the current consumption of the protection IC 205 is reduced.

Since the terminal PS and the terminal VDD are connected to each other by turning the internal switch SW2 (SW2=Ru2) on, the potential at the terminal PS is substantially the same as the potential at the terminal B+ and at the positive electrode 71. Thus, the potential at a second end of the switch 40 is substantially the same as the potential at the terminal B+ and at the positive electrode 71.

When the switch 40 is turned on in the power save mode, the potential level of the terminal PS is changed from a second level that is different from the first level to a third level. In this example, the second level is a potential level that is substantially the same as that of the terminal B+ and the positive electrode 71, and the third level is a potential level that is lower than the second level. In this example, the third level corresponds to a potential level obtained by dividing a cell voltage Vcell by the internal resistor Ru2 and the resistance element Rpd. The resistance value of the internal resistor Ru2 is sufficiently larger than that of the resistance element Rpd.

In the power save mode, the control circuit 23 switches (returns) the operation mode of the protection IC 205 from the power save mode to the normal mode when a state where the potential level of the terminal PS is decreased and is higher than a second threshold value Vps_rel continues for a predetermined time (delay time d2) or longer.

Once the mode is returned to the normal mode, the control circuit 23 turns the discharge control transistor 2 on and blocks the connection between the terminal PS and the terminal VDD by turning the internal switch SW2 off. The control circuit 23 also connects the terminal PS to the terminal VSS (SW2=Rd2), but the terminal PS may be an open output terminal.

As described above, in the fifth embodiment, since the terminal PS and the terminal VDD are connected to each other in the discharge blocked state, the potential at a first end of the switch 40 can be set to be substantially the same as the potential at the terminal VDD and at the positive electrode 71. Therefore, in the discharge blocked state, since the potential level of the terminal PS is changed as the switch 40 is turned on, the control circuit 23 can detect that the switch 40 is turned on, thereby turning the discharge control transistor 2 on. That is, since the power save mode is canceled by turning the switch 40 on without connecting the charger, the convenience of canceling the powered-down state is therefore improved.

Note that, in the fifth embodiment, the terminal VDD is an example of a first power supply terminal, the terminal VSS is an example of a second power supply terminal, the positive electrode 71 is an example of a first electrode, the negative electrode 72 is an example of a second electrode, and the positive-side current path 4 is an example of a discharge path that is connected to the first electrode. Furthermore, in the fifth embodiment, the terminal PS is an example of an input-and-output terminal, and the ground line 312 is an example of a second discharge path that is connected to the second electrode.

Although the embodiments are described as described, the embodiments are presented by way of example, and thus are not intended to limit the present disclosure. The embodiments can be carried out in various other forms, and various combinations, omissions, replacements, changes, and the like can be made without departing from the gist of the present disclosure.

Further, for example, the arrangement positions of the charge control transistor 1 and the discharge control transistor 2 may be replaced with each other with respect to the illustrated positions. Furthermore, the switching circuit 3 may be incorporated in a secondary battery protection integrated circuit.

In the present disclosure, the convenience in releasing a powered-down state is improved.

What is claimed is:

1. A secondary battery protection integrated circuit to protect a secondary battery by inserting a discharge control transistor in a discharge path that is coupled to a first electrode and blocking the discharge path, in a case where a first power supply terminal is coupled to a first electrode of the secondary battery and a second power supply terminal is coupled to a second electrode of the secondary battery, the secondary battery protection integrated circuit comprising:
the first power supply terminal;
the second power supply terminal;
an input terminal;
an output terminal; and
a control circuit configured to:
turn the discharge control transistor off to change to a discharge-blocked state in which the output terminal and the first power supply terminal are coupled to each other, upon occurrence in a condition in which a potential level of the input terminal changes from a first level, and
turn the discharge control transistor on in the discharge blocked state, upon occurrence of a condition in which the input terminal changes from a second level that is different from the first level.

2. The secondary battery protection integrated circuit according to claim 1, wherein the control circuit is configured to turn the discharge control transistor on, upon occurrence in a condition in which, in the discharge blocked state, the potential level of the input terminal is changed from the second level and the changed potential level is maintained for a predetermined time or longer.

3. The secondary battery protection integrated circuit according to claim 2, wherein the control circuit is configured to block connection between the output terminal and the first power supply terminal, upon occurrence of a condition in which, in the discharge blocked state, the potential level of the input terminal is changed from the second level and the changed level is maintained for a predetermined time or longer.

4. The secondary battery protection integrated circuit according to claim 3, wherein the control circuit is configured to couple the output terminal and the second power supply terminal, upon occurrence of a condition in which, in the discharge blocked state, the potential level of the input terminal changes from the second level to the first level and the changed first level is maintained for a predetermined time or longer.

5. The secondary battery protection integrated circuit according to claim 1, wherein the control circuit is configured to couple the input terminal and the second power supply terminal, in the discharge blocked state.

6. A secondary battery protection integrated circuit to protect a secondary battery by inserting a discharge control transistor in a discharge path that is coupled to a first electrode and blocking the discharge path, in a case where a first power supply terminal is coupled to a first electrode of the secondary battery and a second power supply terminal is coupled to a second electrode of the secondary battery, the secondary battery protection integrated circuit comprising:
the first power supply terminal;
the second power supply terminal;
an input-and-output terminal; and
a control circuit configured to:
turn the discharge control transistor off to change to a discharge-blocked state in which the input-and-output terminal and the first power supply terminal are coupled to each other, upon occurrence in a condition in which a potential level of the input terminal changes from a first level, and
turn the discharge control transistor on in the discharge blocked state, upon occurrence of a condition in which the input terminal changes from a second level that is different from the first level.

7. A power supply system comprising:
the secondary battery protection integrated circuit of claim 1;
a switch provided outside the secondary battery protection integrated circuit and configured to switch between connection and disconnection between the input terminal and the output terminal; and
a resistance element electrically coupled between the input terminal and the discharge path.

8. A power supply system comprising:
the secondary battery protection integrated circuit of claim 5; and
a switch provided outside the secondary battery protection integrated circuit and configured to switch between connection and disconnection between the input terminal and the output terminal.

9. A power supply system comprising:
the secondary battery protection integrated circuit of claim 6;
a second discharge path electrically coupled to the second electrode; and
a switch provided outside the secondary battery protection integrated circuit and configured to switch between connection and interruption of the connection that is between the second discharge path and the input-and-output terminal.

10. The power supply system according to claim 9, further comprising:
a diode provided outside the secondary battery protection integrated circuit; and
a backflow prevention circuit electrically coupled to a node between the input-and-output terminal and the switch, the backflow prevention circuit being configured to prevent a current from flowing into the diode.

11. A battery comprising:
the secondary battery protection integrated circuit of claim 1;
the secondary battery; and
the discharge control transistor.
